(19) United States
(12) Patent Application Publication
(10) Pub. No.: US 2023/0231279 A1
(43) Pub. Date: Jul. 20, 2023

(54) BATTERY MODULE AND METHOD FOR MANUFACTURING THE SAME

(71) Applicant: HYUNDAI MOBIS CO., LTD., Seoul (KR)

(72) Inventor: Ho Jin PARK, Yongin-si (KR)

(73) Assignee: HYUNDAI MOBIS CO., LTD., Seoul (KR)

(21) Appl. No.: 18/090,371

(22) Filed: Dec. 28, 2022

(30) Foreign Application Priority Data
Jan. 17, 2022 (KR) 10-2022-0006749

(51) Int. Cl. H01M 50/516; H01M 50/211; H01M 50/178; H01M 50/569; H01M 50/55; H01M 50/557

(52) U.S. Cl. CPC H01M 50/516; H01M 50/211; H01M 50/178; H01M 50/569; H01M 50/55; H01M 50/557

(57) ABSTRACT

Disclosed is a battery module including a battery stack having a structure, in which is stacked batteries, each including an electrode assembly, an outer case accommodating the electrode assembly, and an electrode lead, one side connected to the electrode assembly and an opposite side of which protrudes to an outside of the outer case. The battery module also includes a sensing assembly including a bus bar provided on one side of the battery stack and jointed to the electrode lead. The electrode lead includes a first electrode lead, and a second electrode lead having a polarity that is different from that of the first electrode lead. The battery includes a first battery, and a second battery spaced apart from the battery in a vertical direction, and areas in which the first electrode lead and the second electrode lead are spaced apart from each other in the vertical direction.

### CROSS-REFERENCE TO RELATED APPLICATION

This application claims the benefit under 35 USC § 119(a) of Korean Patent Application No. 10-2022-0006749, filed on Jan. 17, 2022, in the Korean Intellectual Property Office, the entire disclosure of which is incorporated herein by reference for all purposes.

### BACKGROUND

### 1. Field

The present disclosure relates to a battery module, and a method for manufacturing the battery module.

### 2. Description of Related Art

Battery modules are generally provided with a voltage sensing assembly for measuring a voltage of a battery provided in the battery module. The voltage sensing assembly are known to include a bus bar and the bus bar is joined to an electrode lead of the battery mounted on the battery module through welding.

In conventional configurations, a bus bar and an electrode lead are joined to each other in a triple welding scheme, in which a positive electrode lead, a negative electrode lead, and a bus bar provided in a battery are stacked in a three-layered structure and are welded. However, in the triple welding scheme, three base materials are welded to each other. This increases a difficulty in welding and engenders a high possibility of generating a welding defect.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, here is provided a battery module including a battery stack having a structure, in which is stacked batteries, each including an electrode assembly, an outer case accommodating the electrode assembly, and an electrode lead, one side of which is connected to the electrode assembly and an opposite side of which protrudes to an outside of the outer case. The battery module also includes a sensing assembly including a bus bar provided on one side of the battery stack and jointed to the electrode lead. The electrode lead includes a first electrode lead, and a second electrode lead having a polarity that is different from that of the first electrode lead. The battery includes a first battery, and a second battery spaced apart from the battery in a vertical direction, and, spaced apart from each other in the vertical direction, an area, in which the first electrode lead provided in the first battery and the second electrode lead provided in the second battery face each other, and an area, in which the first electrode lead provided in the first battery and the bus bar face each other.

The first electrode lead provided in the first battery and the second electrode lead provided in the second battery may be joined to each other to form a first joining part, the first electrode lead provided in the first battery and the bus bar may be joined to each other to form a second joining part, and the first joining part and the second joining part may be spaced apart from each other in the vertical direction.

The first electrode lead provided in the first battery may include a first protruding area protruding from the outer case provided in the first battery in a horizontal direction, and a first bending area bent from the first protruding area toward the second electrode lead provided in the second battery, and wherein the second electrode lead provided in the second battery may include a second protruding area protruding from the outer case provided in the second battery in the horizontal direction, and a second bending area bent from the second protruding area toward the first electrode lead provided in the first battery.

A length of the first bending area in the vertical direction may be larger than a length of the second bending area in the vertical direction.

A length of the second bending area in the vertical direction may correspond to approximately half of a length of the first bending area in the vertical direction.

The first joining part may be spaced upwards apart from the second joining part.

The second bending area may be spaced upwards apart from the bus bar.

The first bending area may be provided on an inner side of the second bending area in the horizontal direction.

The first bending area may be provided on an inner side of the bus bar in the horizontal direction.

The first electrode lead provided in the first battery and the bus bar may be of the same material.

The first electrode lead provided in the first battery and the second electrode lead provided in the second battery may be of different materials.

The first electrode lead provided in the first battery may be a negative electrode lead, and the second electrode lead provided in the second battery may be a positive electrode lead.

The first bending area may be bent vertically from the first protruding area, and the second bending area may be bent vertically from the second protruding area.

In another general aspect, here is provided a method for manufacturing a battery module, the method including preparing a first battery including a first electrode lead and a first polarity, a second battery including a second electrode lead having a second polarity that is different from the first polarity, and a sensing assembly including a bus bar, stacking the first battery and the second battery such that the first electrode lead provided in the first battery and the second electrode lead provided in the second battery face each other in a vertical direction, bending an outer area of the first electrode lead provided in the first battery in a horizontal direction toward the second electrode lead, and bending an outer area of the second electrode lead provided in the second battery in the horizontal direction toward the first electrode lead, disposing the bus bar on one side of the first electrode lead and the second electrode lead, and welding the first electrode lead, the second electrode lead, and the bus bar to form a joining part, and in the welding, the first electrode lead provided in the first battery and the second electrode lead provided in the second battery are joined to each other to form a first joining part, the first electrode lead provided in the first battery and the bus bar are joined to each other to form a second joining part, and the first joining part and the second joining part are spaced apart from each other in the vertical direction.

In the bending, a first bending area of the first electrode lead, which is bent toward the second electrode lead, may be formed to be longer than a second bending area of the second electrode lead, which is bent toward the first electrode lead, in the vertical direction.

In the welding, the first joining part may be spaced upwards apart from the second joining part.

In the disposing of the bus bar, the bus bar may be spaced downwards from the second bending area.

In the bending, the first electrode lead and the second electrode lead may be bent such that the first bending area is provided on an inner side of the second bending area in the horizontal direction.

In the disposing of the bus bar, the bus bar may be disposed such that the first bending area is provided on an inner side of the bus bar in the horizontal direction.

Other features and aspects will be apparent from the following detailed description, the drawings, and the claims.

### BRIEF DESCRIPTION OF THE DRAWINGS

FIG. 1 is a perspective view illustrating a structure of a battery stack provided in a battery module according to the present disclosure.

FIG. 2 is a side view illustrating a structure of a battery stack provided in a battery module according to the present disclosure.

FIG. 3 is a front view illustrating a structure of a battery module according to the present disclosure.

FIG. 4 is an enlarged view illustrating a joining structure of an electrode lead and a bus bar in a battery module according to the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

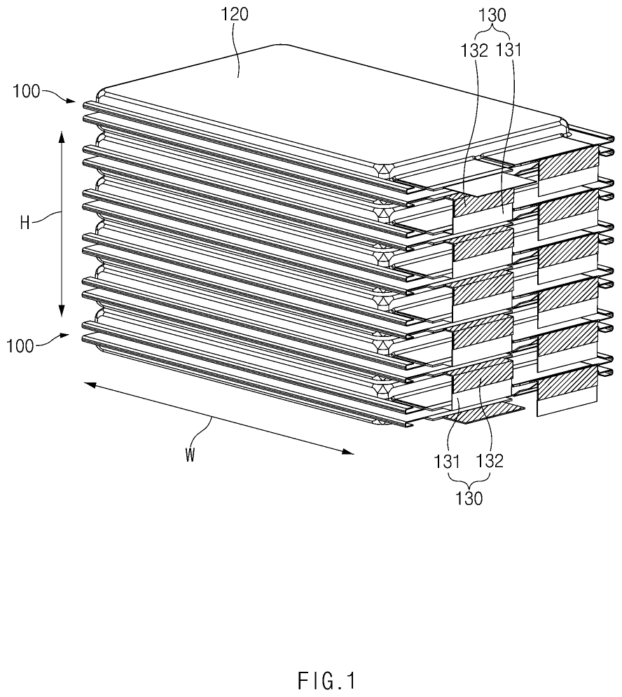

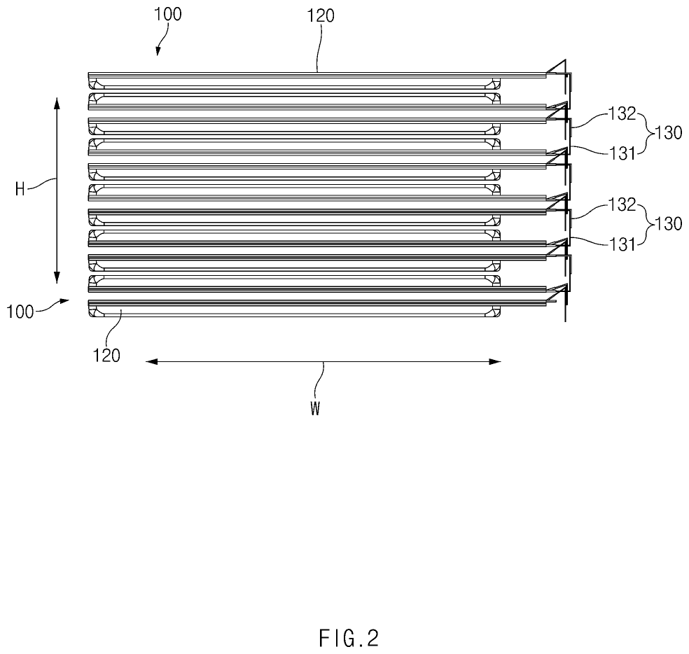

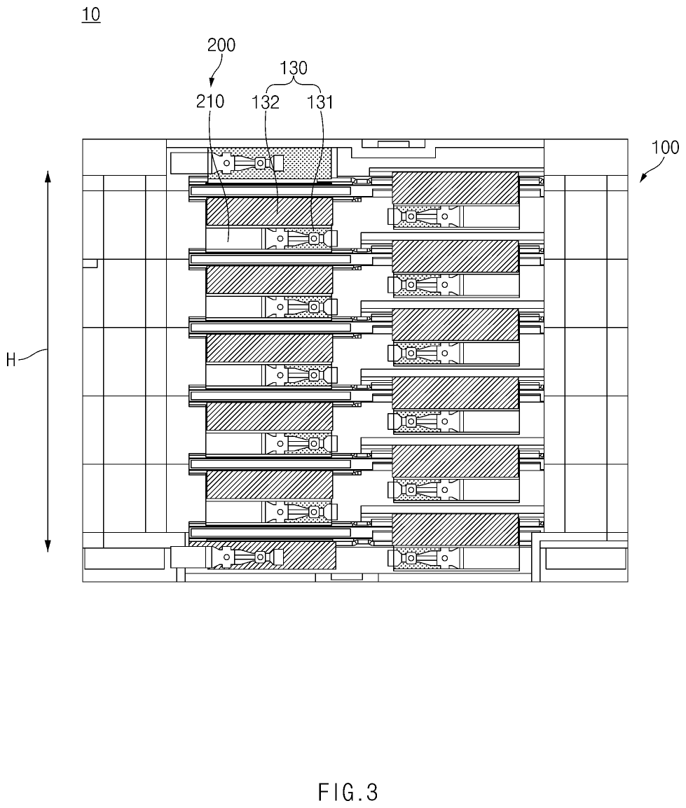

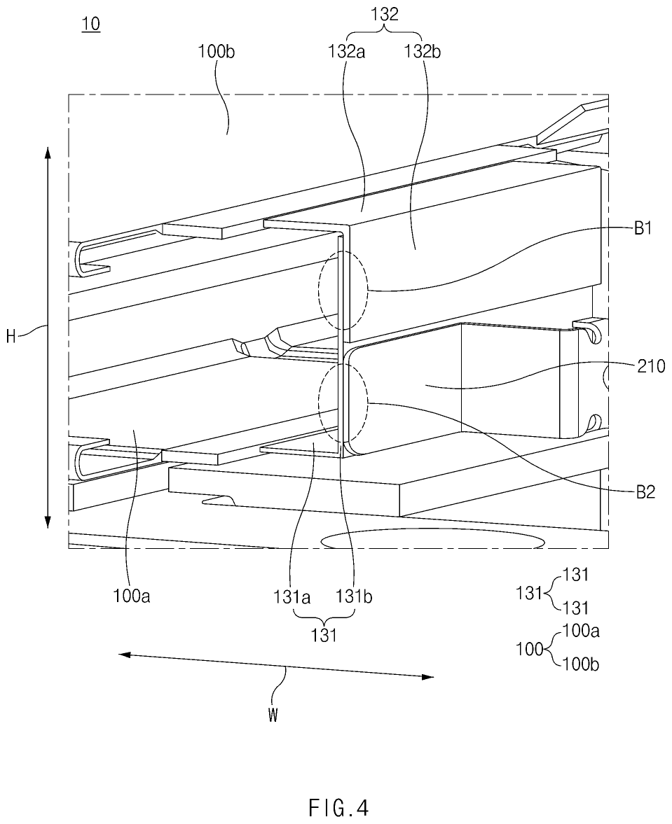

FIG. 1 is a perspective view illustrating a structure of a battery stack provided in a battery module according to the present disclosure. FIG. 2 is a side view illustrating a structure of a battery stack provided in a battery module according to the present disclosure. FIG. 3 is a front view illustrating a structure of a battery module according to the present disclosure. FIG. 4 is an enlarged view illustrating a joining structure of an electrode lead and a bus bar in a battery module according to the present disclosure.

A battery module 10 according to the present disclosure may include a battery stack. The battery stack may have a structure, in which a plurality of batteries 100 each including an electrode assembly having a structure, in which electrodes and separators are alternately stacked, an outer case 120 that accommodates the electrode assembly, and an electrode lead 130, one side of which is connected to the electrode assembly and an opposite side of which protrudes to an outside of the outer case 120 are stacked. As an example, the outer case 120 may be a pouch type outer case. However, the kind of the outer case 120 is not limited to the above-described contents.

The electrode lead 130 may include a first electrode lead 131, and a second electrode lead 132 having a polarity that is different from that of the first electrode lead 131. The first electrode lead 131 and the second electrode lead 132, which have been described above, may be provided in each of the batteries 100 provided in the battery stack. FIGS. 1 to 4 illustrate that the batteries 100 are stacked in the battery stack in a vertical direction “H” and the electrode lead 130 protrudes from the outer case 120 of the battery 100 to one side of a horizontal direction “W”. As an example, the first electrode lead 131 and the second electrode lead 132 may protrude from one side of the outer case 120 in the same direction.

The battery module 10 may include a sensing assembly 200 provided on one side of the above-described battery stack and including a bus bar 210 joined to the electrode lead 130. The sensing assembly 200 may be a configuration for measuring a voltage of the battery 100 provided in the battery module 10. To achieve this, the bus bar 210 provided in the sensing assembly 200 needs to be joined to the electrode lead 130 of the battery 100.

As an example, the batteries 100 provided in the battery stack may include a first battery 100a, and a second battery 100b that is spaced upwards apart from the first battery 100a in the vertical direction “H”. The battery stack may further include a larger number of batteries in addition to the first battery 100a and the second battery 100b, but the battery stack including the first battery 100a and the second battery 100b will be mainly described below for convenience of description.

As described above, the batteries 100 may include the first electrode lead 131 and the second electrode lead 132. Accordingly, the first electrode lead 131 may be provided in the first battery 100a, and the second electrode lead 132 may be provided in the second battery 100b.

Then, according to the present disclosure, the first electrode lead 131 provided in the first battery 100a and the second electrode lead 132 provided in the second battery 100b may be joined to each other to form a first joining part B1, and the first electrode lead 131 provided in the first battery 100a and the bus bar 210 of the sensing assembly 200 may be joined to each other to form a second joining part B2.

In more detail, referring to FIG. 1, an area, in which the first electrode lead 131 provided in the first battery 100a and the second electrode lead 132 provided in the second battery 100b face each other, and an area, in which the first electrode lead 131 provided in the first battery 100a and the bus bar 210 face each other, may be spaced apart from each other in the vertical direction “H”. Then, the first joining part B1 may be formed in an area, in which the first electrode lead 131 provided in the first battery 100a and the second electrode lead 132 provided in the second battery 100b face each other, and the second joining part B2 may be formed in an area, in which the first electrode lead 131 provided in the first battery 100a and the bus bar 210 face each other. Accordingly, according to the present disclosure, the first joining part B1 and the second joining part B2 may be spaced apart from each other in the vertical direction “H”.

As described above, according to the present disclosure, because the area, in which the first electrode lead 131 provided in the first battery 100a and the second electrode lead 132 provided in the second battery 100b face each other, and the area, in which the first electrode lead 131 provided in the first battery 100a and the bus bar 210 face each other, may be spaced apart from each other in the vertical direction “H”, the electrode lead 130 and the bus bar 210 may be stacked not in a three-layered structure but in a two-layered structure. Accordingly, according to the present disclosure, because a difficulty in joining the electrode lead 130 and the bus bar 210 through welding is solved unlike the conventional technology, a quality of welding in the joining parts B1 and B2 may be remarkably enhanced.

Meanwhile, referring to the drawings, the first electrode lead 131 and the second electrode lead 132 according to the present disclosure may have a bent structure.

In more detail, the first electrode lead 131 provided in the first battery 100a may include a first protruding area 131a that protrudes from the outer case 120 provided in the first battery 100a in the horizontal direction “W”, and a first bending area 131b that is bent from the first protruding area 131a toward the second electrode lead 132 provided in the second battery 100b. As an example, it may be understood that the first electrode lead 131 may have an “L” shape that is bent substantially toward the second battery 100b.

Furthermore, the second electrode lead 132 provided in the second battery 100b may include a second protruding area 132a that protrudes from the outer case 120 provided in the second battery 100b in the horizontal direction “W”, and a second bending area 132b that is bent from the second protruding area 132a toward the first electrode lead 131 provided in the first battery 100a. As an example, it may be understood that the second electrode lead 132 may have an “L” shape that is bent substantially toward the first battery 100a.

Meanwhile, as described above, a length of the first bending area 131b in the vertical direction “H” may be larger than a length of the second bending area 132b in the vertical direction “H” such that the first joining part B1 and the second joining part B2 are spaced apart from each other in the vertical direction “H”. Accordingly, according to the present disclosure, a portion of the first bending area 131b may face the second bending area 132b to form the first joining part B1, and another portion of the second bending area 132b may face the bus bar 210 to form the second joining part B2. As an example, a length of the second bending area 132b in the vertical direction “H” may correspond to a half of a length of the first bending area 131b in the vertical direction “H”.

Meanwhile, as illustrated in FIG. 4, an area, in which the first electrode lead 131 provided in the first battery 100a and the second electrode lead 132 provided in the second battery 100b face each other, and an area, in which the first electrode lead 131 provided in the first battery 100a and the bus bar 210 face each other, may be spaced upwards apart from each other in the vertical direction “H”. Accordingly, the first joining part Bi may be spaced upwards apart from the second joining part B2. Furthermore, the second bending area 132b may be spaced upwards apart from the bus bar 210.

Continuously, referring to FIG. 4, the first bending area 131b may be provided on an inner side of the second bending area 132b in the horizontal direction “W”.

As an example, a melting point of the first electrode lead 131 may be lower than a melting point of the second electrode lead 132.

According to the present disclosure, in a welding process, a welding apparatus (not illustrated) may be provided while facing an outer surface of one of the two electrodes, which is provided an outer side in the horizontal direction “W”, in the horizontal direction “W”.

Then, when an outer surface of an electrode lead having a relatively low melting point, that is, the first electrode lead 131 directly faces the welding apparatus, the first electrode lead 131 having a low melting point may be damaged in the welding process whereby a possibility of generating a welding defect may be increased significantly.

Accordingly, according to the present disclosure, the first electrode lead 131 having a relatively low melting point is provided on an inner side of the second electrode lead 132 in the horizontal direction “W”, whereby the first electrode lead 131 may be prevented from directly facing the welding apparatus. Accordingly, the first electrode lead 131 may be prevented from being damaged in the welding process so that a quality of the welding deteriorates.

Furthermore, as illustrated in FIG. 4, the first bending area 131b may be provided on an inner side of the bus bar 210 in the horizontal direction “W”.

As an example, a melting point of the first electrode lead 131 may be lower than a melting point of the bus bar 210. Meanwhile, in the welding process, the welding apparatus (not illustrated) may be provided while facing an outer surface of one of the electrode lead 130 and the bus bar 210, which is provided on an outer side in the horizontal direction “W”, in the horizontal direction “W”.

Then, when an outer surface of an electrode lead having a relatively low melting point, that is, the first electrode lead 131 directly faces the welding apparatus, the first electrode lead 131 having a low melting point may be damaged in the welding process whereby a possibility of generating a welding defect may be increased significantly.

Accordingly, according to the present disclosure, the first electrode lead 131 having a relatively low melting point is provided on an inner side of the bus bar 210 in the horizontal direction “W”, whereby the first electrode lead 131 may be prevented from directly facing the welding apparatus. Accordingly, the first electrode lead 131 may be prevented from being damaged in the welding process so that a quality of the welding deteriorates.

Meanwhile, according to the present disclosure, the first electrode lead 131 provided in the battery 100 including the first battery 100a and the bus bar 210 may be of the same material. Meanwhile, the first electrode lead 131 provided in the battery 100 including the first battery 100a and the second electrode lead 132 provided in the battery 100 including the second battery 100b may be of different materials. For example, the first electrode lead 131 and the bus bar 210 may be of a copper material, and the second electrode lead 132 may be of an aluminum material. Furthermore, the first electrode lead 131 provided in the battery 100 including the first battery 100a may be a negative electrode lead, and the second electrode lead 132 provided in the battery 100 including the second battery 100b may be positive electrode lead.

Meanwhile, as illustrated in FIG. 4, the first bending area 131b may be bent vertically from the first protruding area 131a, and the second bending area 132b may be bent vertically from the second protruding area 132a. However, unlike the above description, the first bending area 131b may be bent at an astute angle from the first protruding area 131a, and the second bending area 132b may be bent at an astute angle from the second protruding area 132a.

Referring to the drawings, a method for manufacturing a battery module may include a preparation operation of preparing the first battery 100a including the first electrode lead 131, the second battery 100b including the second electrode lead 132 having a polarity that is different from that of the first electrode lead 131, and the sensing assembly 200 including the bus bar 210, a stacking operation of stacking the first battery 100a and the second battery 100b such that the first electrode lead 131 provided in the first battery 100a and the second electrode lead 132 provided in the second battery 100b face each other in the vertical direction “H”, a bending operation of bending an outer area of the first electrode lead 131 provided in the first battery 100a in a horizontal direction “W” toward the second electrode lead 132, and bending an outer area of the second electrode lead 132 provided in the second battery 100b in the horizontal direction “W” toward the first electrode lead 131, and a welding operation of welding the first electrode lead 131, the second electrode lead 132, and the bus bar 210 to form the joining part B1 and B2.

Then, according to the present disclosure, in the welding operation, the first electrode lead 131 provided in the first battery 100a and the second electrode lead 132 provided in the second battery 100b may be joined to each other to form the first joining part B1, and the first electrode lead 131 provided in the first battery 100a and the bus bar 210 may be joined to each other to form the second joining part B2. Furthermore, the first joining part B1 and the second joining part B2 may be spaced apart from each other in the vertical direction “H”.

Meanwhile, according to the present disclosure, in the bending operation, the first bending area 131b of the first electrode lead 131, which is bent toward the second electrode lead 132, may be formed to be longer than the second bending area 132b of the second electrode lead 132, which is bent toward the first electrode lead 131, in the vertical direction “H”.

Furthermore, in the welding operation, the first joining part B1 may be spaced upwards apart from the second joining part B2.

Furthermore, in the bus bar disposing operation, the bus bar 210 may be disposed to be spaced downwards apart from the second bending area 132b.

Meanwhile, in the bending operation, the first electrode lead 131 and the second electrode lead 132 may be bent such that the first bending area 131b is provided on an inner side of the second bending area 132b in the horizontal direction “W”. This may be for minimizing damage to the first bending area 131b having a relatively low melting point in the welding process.

Furthermore, in the bus bar disposing operation, the bus bar may be disposed such that the first bending area 131b is provided on an inner side of the bus bar 210 in the horizontal direction “W”.

Meanwhile, in relation to the structure of the battery module according to the present disclosure, the above-described content may be applied to the method for manufacturing the battery module according to the present disclosure in the same way, and vice versa.

Various embodiments of the present disclosure do not list all available combinations but are for describing a representative aspect of the present disclosure, and descriptions of various embodiments may be applied independently or may be applied through a combination of two or more.

An aspect of the present disclosure enhances a quality of a welding area formed in a battery module by enhancing a welding quality of an electrode lead and a bus bar of the battery module.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery module comprising:
a battery stack having a structure in which is stacked:
batteries each including an electrode assembly,
an outer case accommodating the electrode assembly, and
an electrode lead, one side of which is connected to the electrode assembly and an opposite side of which protrudes to an outside of the outer case; and
a sensing assembly including a bus bar provided on one side of the battery stack and jointed to the electrode lead,
wherein the electrode lead includes:
a first electrode lead; and
a second electrode lead having a polarity different from that of the first electrode lead,
wherein the battery includes:
a first battery; and
a second battery spaced apart from the battery in a vertical direction, and, spaced apart from each other in the vertical direction,
an area, in which the first electrode lead provided in the first battery and the second electrode lead provided in the second battery face each other, and
an area, in which the first electrode lead provided in the first battery and the bus bar face each other.

2. The battery module of claim 1, wherein the first electrode lead provided in the first battery and the second electrode lead provided in the second battery are joined to each other to form a first joining part,
wherein the first electrode lead provided in the first battery and the bus bar are joined to each other to form a second joining part, and
wherein the first joining part and the second joining part are spaced apart from each other in the vertical direction.

3. The battery module of claim 2, wherein the first electrode lead provided in the first battery includes:
a first protruding area protruding from the outer case provided in the first battery in a horizontal direction; and
a first bending area bent from the first protruding area toward the second electrode lead provided in the second battery, and
wherein the second electrode lead provided in the second battery includes:
a second protruding area protruding from the outer case provided in the second battery in the horizontal direction; and
a second bending area bent from the second protruding area toward the first electrode lead provided in the first battery.

4. The battery module of claim 3, wherein a length of the first bending area in the vertical direction is larger than a length of the second bending area in the vertical direction.

5. The battery module of claim 4, wherein a length of the second bending area in the vertical direction corresponds to approximately half of a length of the first bending area in the vertical direction.

6. The battery module of claim 4, wherein the first joining part is spaced upwards apart from the second joining part.

7. The battery module of claim 4, wherein the second bending area is spaced upwards apart from the bus bar.

8. The battery module of claim 3, wherein the first bending area is provided on an inner side of the second bending area in the horizontal direction.

9. The battery module of claim 3, wherein the first bending area is provided on an inner side of the bus bar in the horizontal direction.

10. The battery module of claim 1, wherein the first electrode lead provided in the first battery and the bus bar are of the same material.

11. The battery module of claim 1, wherein the first electrode lead provided in the first battery and the second electrode lead provided in the second battery are of different materials.

12. The battery module of claim 1, wherein he first electrode lead provided in the first battery is a negative electrode lead, and
wherein the second electrode lead provided in the second battery is a positive electrode lead.

13. The battery module of claim 3, wherein the first bending area is bent vertically from the first protruding area, and
wherein the second bending area is bent vertically from the second protruding area.

14. A method for manufacturing a battery module, the method comprising:
preparing a first battery including a first electrode lead and a first polarity, a second battery including a second electrode lead having a second polarity that is different from the first polarity, and a sensing assembly including a bus bar;
stacking the first battery and the second battery such that the first electrode lead provided in the first battery and the second electrode lead provided in the second battery face each other in a vertical direction;
bending an outer area of the first electrode lead provided in the first battery in a horizontal direction toward the second electrode lead, and bending an outer area of the second electrode lead provided in the second battery in the horizontal direction toward the first electrode lead;
disposing the bus bar on one side of the first electrode lead and the second electrode lead; and
welding the first electrode lead, the second electrode lead, and the bus bar to form a joining part, and
wherein in the welding,
the first electrode lead provided in the first battery and the second electrode lead provided in the second battery are joined to each other to form a first joining part, the first electrode lead provided in the first battery and the bus bar are joined to each other to form a second joining part, and the first joining part and the second joining part are spaced apart from each other in the vertical direction.

15. The method of claim 14, wherein in the bending, a first bending area of the first electrode lead, which is bent toward the second electrode lead, is formed to be longer than a second bending area of the second electrode lead, which is bent toward the first electrode lead, in the vertical direction.

16. The method of claim 15, wherein in the welding, the first joining part is spaced upwards apart from the second joining part.

17. The method of claim 15, wherein in the disposing of the bus bar, the bus bar is spaced downwards from the second bending area.

18. The method of claim 15, wherein in the bending, the first electrode lead and the second electrode lead are bent such that the first bending area is provided on an inner side of the second bending area in the horizontal direction.

19. The method of claim 15, wherein in the disposing of the bus bar, the bus bar is disposed such that the first bending area is provided on an inner side of the bus bar in the horizontal direction.
